(19) United States
(12) Patent Application Publication
(10) Pub. No.: US 2011/0124416 A1
(43) Pub. Date: May 26, 2011

(54) PLAY RESULT PROCESSING SYSTEM

(75) Inventors: Hiroyuki Masuda, Kobe (JP); Koji Makino, Kobe (JP); Yoshito Fukuda, Kobe (JP); Masanori Kono, Kobe (JP); Masato Otsuka, Yokohama (JP); Takayuki Akita, Tokyo (JP)

(73) Assignee: Konami Digital Entertainment Co., Ltd., Minato-ku, Tokyo (JP)

(21) Appl. No.: 13/055,396

(22) PCT Filed: Jul. 14, 2009
(86) PCT No.: PCT/JP2009/062709

§ 371 Date: Jan. 21, 2011

(30) Foreign Application Priority Data
Jul. 23, 2008 (JP) 2008-190221

(51) Int. Cl. A63F 9/24; A63F 13/02

(52) U.S. Cl. 463/42

(57) ABSTRACT

A play result processing system includes a first storage part for storing player identifiers, each of which is unique to a player of a computer game and for storing medium identifiers each of which is unique to an information storage medium used for playing the computer game, each one of the player identifiers being associated with at least one of the medium identifiers in the first storage part. The play result processing system also includes a second storage part for storing the player identifiers and data-generation information elements, each of the data-generation information elements being necessary for generating a data element that indicates a message in a manner that is unique to the player corresponding to the message, the player identifier for each single player being associated with the data-generation information element for the player in the second storage part. The play result processing system receives data indicating a set including a play result and a medium identifier for an information storage medium used for the play; generates a message that indicates the play result contained in the set indicated by the data received at the receiver in a manner that is unique to a player, the manner depending on the data-generation information element associated in the second storage part with the player identifier that is associated in the first storage part with the medium identifier received at the receiver; and transmits the generated message to a webpage production system.

### TECHNICAL FIELD

The present invention relates to a technique for processing a result of a play in a computer game.

### BACKGROUND ART

Patent Document 1 discloses a network game system that produces a webpage describing the result of a play in a computer game for each of the client computers, which enters a game server for performing a computer game. Patent Document 1 also discloses that IDs and passwords are used to identify players.
Patent Document 1: JP-A-2008-36242

### DISCLOSURE OF INVENTION

### Problems to be Solved by Invention

In the system described in Patent Document 1, the webpage representing the result of a play in a computer game is produced for each client computer. If a client computer is used by multiple players, the same webpage will report a player's play result and another player's play result, and it will be vague whose results are reported on the webpage.

Let us assume that there is a system in which a player is identified by an ID and by a password, and in which a webpage describing the result of a play in a computer game is produced for each identified player. This system will be referred to as a “first system”. An advantage of the first system is clarifying whose result is reported by a webpage even if a client computer is used by multiple players since the webpage is produced for each player or each player's website.

Webpage production systems have been in widespread use in which a user who uses an account given to the user for producing a webpage and for adding (recording) the webpage to a website that is unique to the account. Such a webpage production system will be referred to as a “second system”. If the second system is used, it is possible to simplify the system for automatically producing a webpage representing the result of a play in a computer game.

A game system is known in which a player uses an information storage medium storing a unique medium identifier for playing a computer game. Once a play is completed, the game system records the result of the play in association with the medium identifier of the information storage medium used for the play. One type of game system is a game system in which each individual player may possess multiple information storage mediums; this system will be referred to as a “third system”. An advantage of the third system is managing the result of a play in the computer game for each medium identifier when a player, who possesses multiple information storage media, uses the information storage media.

Let us assume the construction of a system based on the second system and having the advantages of the first and the third systems. In such a system, an account is given to each medium identifier for using the second system, the result of a play in a computer game is recorded for each medium identifier, a webpage describing the play result is produced for each medium identifier, and then the webpage is added to a website that is unique to the account corresponding to the medium identifier. However, such a system has a drawback in that webpages each describing the result of a play by a single player will be distributed to multiple websites when the player uses a plurality of information storage media.

Accordingly, it is an object of the present invention to provide a play result processing system with a simple structure for automatically producing a webpage describing the result of a play by a player and for adding the webpage to an individual website for the player.

### Means for Solving the Problems

In order to solve the above problems, the present invention provides a play result processing system for transmitting a message to a webpage production system that receives a message indicating information in a manner that is unique to a user corresponding to the information, generates a webpage describing the information using the message, and adds the generated webpage to a website for the user, the play result processing system including: a first storage part for storing player identifiers each of which is unique to a player of a computer game and for storing medium identifiers each of which is unique to an information storage medium used for playing the computer game, each one of the player identifiers being associated with at least one of the medium identifiers in the first storage part; a second storage part for storing the player identifiers and data-generation information elements, each of the data-generation information elements being necessary for generating a data element that indicates a message in a manner that is unique to the player corresponding to the message, the player identifier for each single player being associated with the data-generation information element for the player in the second storage part; a receiver for receiving data indicating a set including a play result which is a result of play of the computer game and a medium identifier for an information storage medium used for the play; a generator for generating a message that indicates the play result contained in the set indicated by the data received at the receiver in a manner that is unique to a player, the manner depending on the data-generation information element associated in the second storage part with the player identifier that is associated in the first storage part with the medium identifier contained in the set indicated by the data received at the receiver; and a transmitter for transmitting the message generated at the generator to the webpage production system.

Since the website production system can be an existing system, if the play result processing system is used, the website production system with a simple structure can automatically produce a webpage describing the result of a play by a player, and can add the webpage to an individual website for the player. The “message indicating (or that indicates) . . . in a manner that is unique to a user (or a player)” includes, for example, a message to which information for identifying the user or the player is attached. More specifically, such a message includes an electronic mail to which the user's or player's electronic mail address is attached as the information for identifying the user or the player. Alternatively, the “message indicating (or that indicates) . . . in a manner that is unique to a user (or a player)” may be a message of which the information arrangement or the style is unique to the user or the player.

In the play result processing system, the data-generation information element may be an electronic mail address for the player. The generator may generate an electronic mail, as the message, including a source mail address, a body, and a title, the source mail address being the data-generation information element associated in the second storage part with the player identifier which is associated in the first storage part with the medium identifier contained in the set indicated by the data received at the receiver, the body or the title including the play result contained in the set. The transmitter may transmit the electronic mail to the webpage production system. In this aspect of the play result processing system, the message sent to the webpage production system is an electronic mail. The communication protocol for electronic mails is widely popular, and therefore this aspect of the play result processing system can reduce the effort for constructing the system and can use many types of webpage production systems, in comparison with another aspect in which a message is sent in accordance with a communication protocol that is not popular.

### Effects of Invention

According to the present invention, a system with a simple structure can automatically produce a webpage describing the result of a play by a player and can add the webpage to an individual website for the player.

### BRIEF DESCRIPTION OF THE DRAWINGS

FIG. 1 is a block diagram showing the structure of a communication system according to an embodiment of the present invention.

FIG. 2 is a perspective view showing the appearance of a game terminal in the communication system.

FIG. 3 is a view showing the positional relationship between a picture screen and manual operation buttons in the game terminal.

FIG. 4 is a view showing an example of an image shown on a region of the screen.

FIG. 5 is a view showing an example of an image shown on another region of the screen.

FIG. 6 is a schematic view showing the architecture of a play result management table saved in a storage part of the play result processing system in the communication system.

FIG. 7 is a schematic view showing the architecture of a first association table saved in the storage part.

FIG. 8 is a schematic view showing the architecture of a second association table saved in the storage part.

FIG. 9 is a flowchart showing the flow of a play result storing process executed by a processor in the play result processing system.

FIG. 10 is a flowchart showing the flow of an electronic mail generation process executed by the processor.

FIG. 11 is a schematic view showing an example of an electronic mail generated by the processor.

FIG. 12 is a view showing an image of a webpage produced by a webpage production system in the communication system.

FIG. 13 is a view for describing a modified embodiment.

FIG. 14 is a view for describing another modification of the embodiment.

### DESCRIPTION OF EMBODIMENTS

With reference to the accompanying drawings, a preferred embodiment of the present invention will be described. The structure specifically described below is only an example of the invention, and the present invention encompasses various modifications of the specific structure.

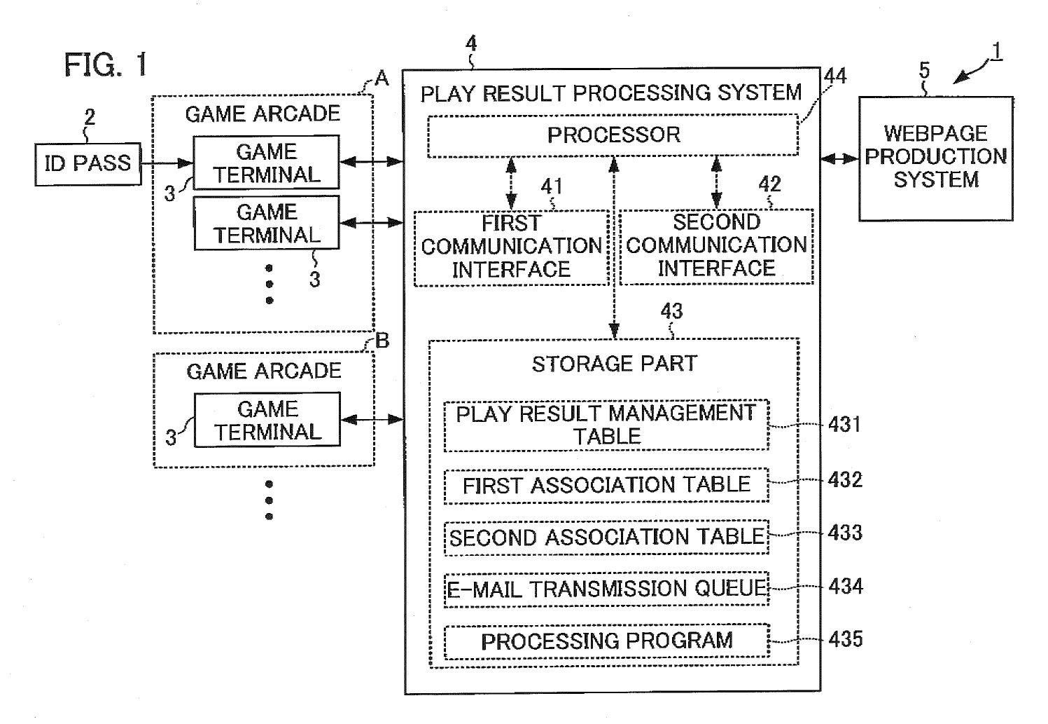

FIG. 1 is a block diagram showing the structure of a communication system 1 according to an embodiment of the present invention. The communication system 1 invites players to play a specific computer game, automatically produces webpages describing results of plays, and adds (records) the individual webpage to an individual website dedicated to the individual player. The communication system 1 includes ID passes 2, multiple game terminals 3, a play result processing system 4, and a webpage production system 5. An example of the computer game is a music video game in which a player operates operation elements in tune with music being played.

Each ID pass 2 is an information storage medium used for playing the computer game, and preferably has a shape of a card that is portable. In FIG. 1, only one ID pass 2 is illustrated, but actually, there are numerous ID passes 2. Each ID pass 2 stores a unique pass ID (medium identifier). For example, pass ID “1” is recorded in the illustrated ID pass 2. Each single player can possess one or more ID passes 2.

The game terminal 3 is a computer in which the computer game can be played. The game terminal 3 is an arcade game machine in which players play the computer game by, payment of a charge. In multiple game arcades A, B, . . . , to which a large indefinite number of people come, one or more game terminals 3 are provided.

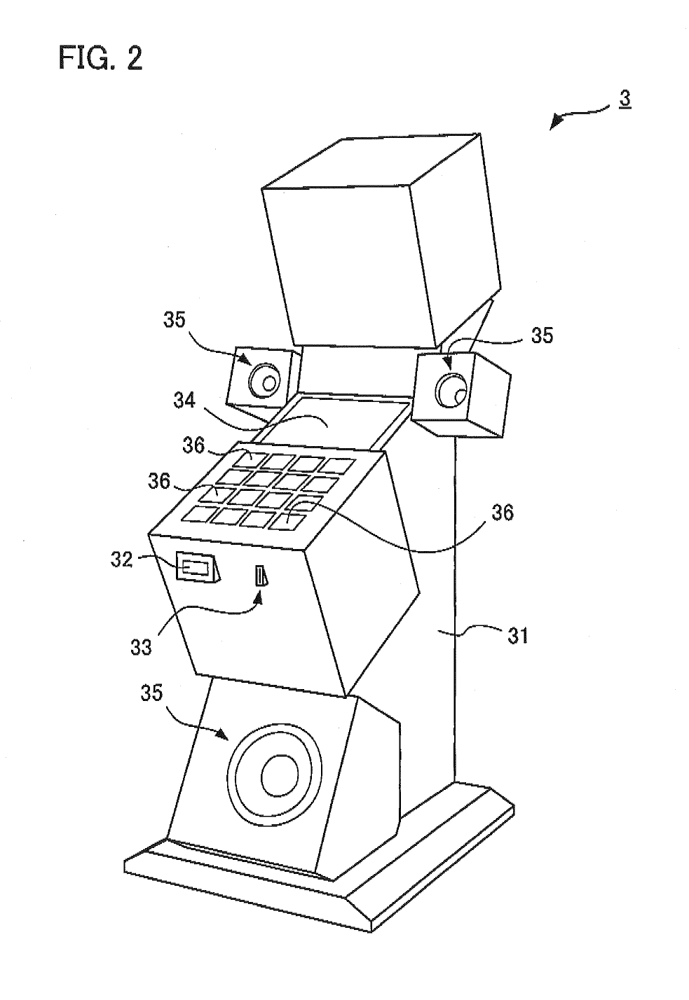

FIG. 2 is a perspective view showing the appearance of the game terminal 3. The game terminal 3 includes a housing 31 in which are provided a pass reader 32 for reading the pass ID from an ID pass 2, and a slot 33 into which predetermined coins are dropped. The principle for reading the pass ID by the pass reader 32 is optional, but it is necessary to conform to the type of recording method for ID passes 2. The predetermined coins are one or more coins having a value equivalent to the charge for a play of the computer game, and may be, for example, hard cash coins, or token coins sold by a game company. A player may select an optional ID pass 2 among the player's multiple ID passes 2 for playing the computer game if the player has multiple ID passes. He or she causes the pass reader 32 to read and to temporarily store the pass ID of his or her ID pass 2, drops the predetermined coins equivalent to the charge of playing the computer game, and then can play the computer game.

On the housing 31, a screen 34, multiple speakers 35, and 16 manual operation buttons 36 arranged into a matrix of four rows and four columns are provided. In playing the computer game, the player listens to a music composition from the speakers 35, watches the video image corresponding to the music composition displayed on the screen 34, and should operate appropriate manual operation buttons 36 at the proper timing. The result of a play in the computer game (hereinafter referred to as “play result”) is better when the player has performed appropriate operations, and is worse when the player has performed inappropriate operations.

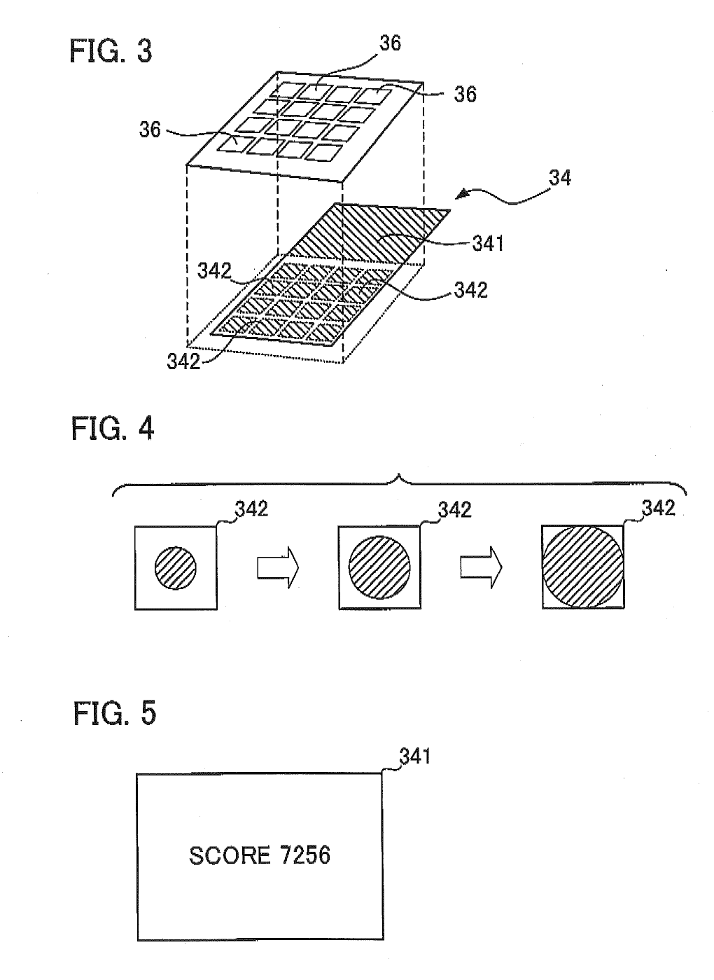

FIG. 3 is a view showing the positional relationship between the picture screen 34 and the manual operation buttons 36. As shown in FIG. 3, 16 manual operation buttons 36 are superimposed on the screen 34. The manual operation buttons 16 are made of a material with a high light transmissibility. Therefore, the player can view a video image on each of 16 regions 342 arranged into a matrix of four rows and four columns in the screen 34 through the corresponding manual operation buttons 36, each of the regions indicating the time point at which the player should operate and the corresponding manual operation button 36 to be operated. The player can also view another region 341, on which the play result is shown, that is not covered with manual operation buttons 36.

FIG. 4 is a view showing an example of a video image shown on each region 342. For this example, the circle shown at the center of the region 342 increasingly becomes enlarged. The time point at which the circle becomes so large that the periphery comes into contact with the contour of the region 342 is the time point at which the manual operation button 36 over the region 342 should be operated.

FIG. 5 is a view showing an example of a video image shown on the region 341. The score shown in FIG. 5 is a parameter that increases when the player has performed an appropriate operation and decreases when the player has performed an inappropriate operation, and is updated during the play of the computer game.

The play result is the score at one play of the computer game when it has been completed. Once a play of the computer game is completed, the game terminal 3 transmits a set including the pass ID recorded in the ID pass 2 used for the play and the play result to the play result processing system 4. This transmission may be sending a data element that indicates the set.

With reference to FIG. 1 again, details of the play result processing system 4 and the webpage production system 5 will be described. The webpage production system 5 is an existing system that enables individual users to construct individual webpages, each of which is dedicated to a single user. Upon receiving an electronic mail with a source mail address that is one of electronic mail addresses registered in association with the users in advance, the webpage production system 5 produces or generates a webpage that describes the title and the body of the electronic mail in a document description language, such as HTML (Hypertext Markup Language), and adds the webpage to the website for the user. A “webpage” is a document constituting the WWW (World Wide Web), and a “website” is a collection of multiple webpages.

The play result processing system 4 is a computer system composed of one or more computers. The play result processing system 4 includes a first communication interface 41 for exchanging data with each game terminal 3, a second communication interface 42 for exchanging data with the webpage production system 5, storage part 43 for storing information as data, and a processor 44 for executing various processes. The storage part 43 is, for example, a rewritable memory (for example, a RAM (Random Access Memory)) or a hard disc. In the memory area of the storage part 43, a play result management table 431, a first association table (first storage part) 432, a second association table (second storage part) 433, and an electronic mail transmission queue (e-mail transmission queue) 434 are reserved.

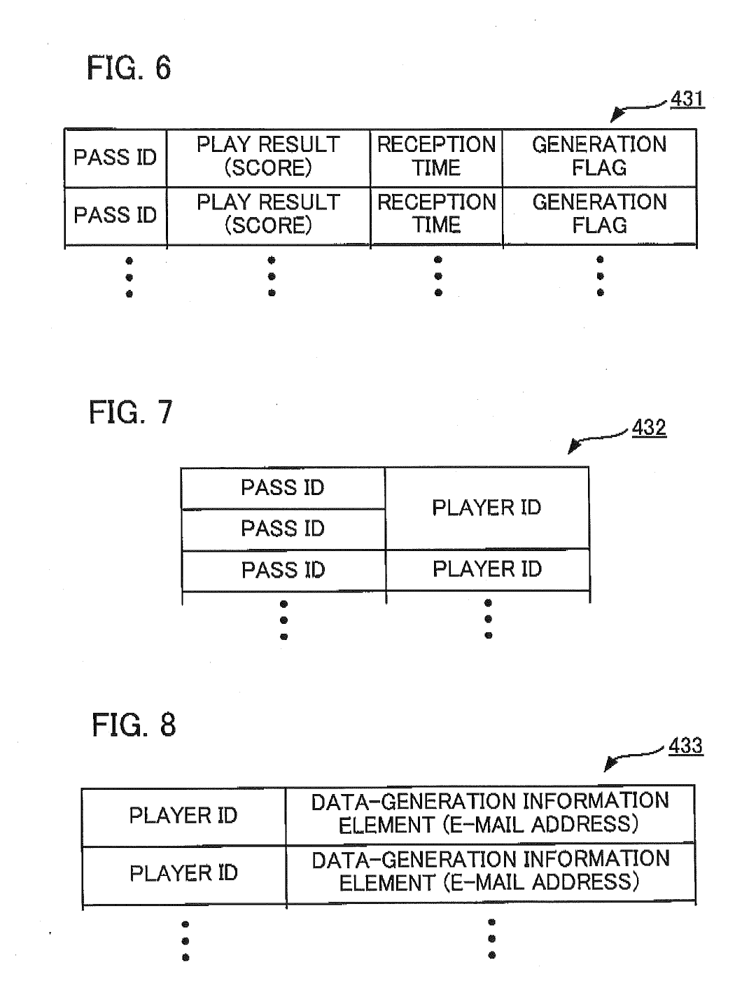

FIG. 6 is a schematic view showing the architecture of the play result management table 431. As shown in FIG. 6, the play result management table 431 stores, for each set of the pass ID and the play result, the pass ID, the play result, a reception time that is the time point at which the set is received, and a generation flag indicating whether an electronic mail containing the play result in the body thereof (hereinafter, referred to as a “play-result-report mail”) has been generated or not. In other words, the pass ID, the play result, the reception time, and the generation flag are associated with one another in the table. Recording thereof is accomplished by, for example, writing data indicating the pass ID, the play result, the reception time, and the generation flag that correspond to one another into the play result management table 431.

FIG. 7 is a schematic view showing the architecture of the first association table 432. As shown in FIG. 7, the first association table 432 stores, for each player, the player ID (player identifier) unique to the player and one or more pass IDs recorded in one or more ID passes 2 possessed by the player. In other words, the player ID and one or more pass IDs are associated with each other in the table. Recording thereof is accomplished by, for example, writing data indicating the player ID and the pass ID that correspond to each other into the first association table 432. The following description of an electronic mail generation process is based on the player IDs and pass IDs that are necessary for the electronic mail generation process having been already stored.

FIG. 8 is a schematic view showing the architecture of the second association table 433. As shown in FIG. 8, the second association table 433 stores, for each player, the player ID for the player and a data-generation information element necessary for generating a play-result-report mail for reporting a play result by the player. In other words, the player ID and the data-generation information element are associated with each other in the table. Recording thereof is accomplished by, for example, writing data indicating the player ID and the data-generation information element that correspond to each other into the second association table 433. Each data-generation information element is specifically the electronic mail address of the player. For example, the data-generation information element for each player is an electronic mail address that has been registered with the webpage production system 5. The following description of an electronic mail generation process is based on player IDs and data-generation information elements that are necessary for the electronic mail generation process having been already stored.

The e-mail transmission queue 434 shown in FIG. 1 is a queue for sending play-result-report mails, and retains the generated play-result-report mails. The processing program 435 is a computer program executed by a processor 43. The processor 43 is composed of one or more processors, and achieves the following functions by executing the processing program 435.

The processor 43 serves as a timer for cooperating with a real time clock to indicate the current time, a receiver for cooperating with the first communication interface 41 to receive sets each including the play result and the pass ID from game terminals, and a transmitter for cooperating with the second communication interface 42 to transmit sequentially play-result-report mails retained in the e-mail transmission queue 434 to the webpage production system 5.

By running the processing program 435, the processor 43 executes in parallel a play result storing process for storing information such as a play result, an electronic mail generation process for generating or producing a play-result-report mail, and an electronic mail transmission process for extracting play-result-report mails sequentially from the e-mail transmission queue 434 and transmitting the mails. The electronic mail transmission process is the same as the usual electronic mail transmission process, and therefore, the play result storing process and the electronic mail generation process will be described in detail.

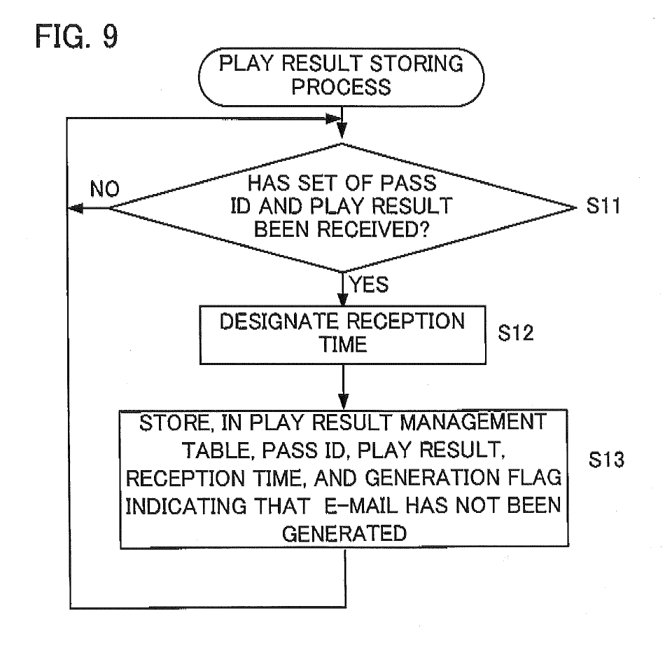

FIG. 9 is a flowchart showing the flow of the play result storing process. As shown in FIG. 9, in the play result storing process, the processor 44 first determines whether or not it has received a set of a pass ID and a play result (S11). If the determination is “No”, the process returns to step S11. That is, the processor 44 waits until receiving a set of a pass ID and a play result. If the determination at step S11 is “Yes”, the processor 44 designates the current time as the reception time for the set received (S12). The processor 44 stores, in the play result management table 431, the received set (the pass ID and the play result), the reception time designated at step S12, and a generation flag indicating that an electronic mail containing the play result has not been generated in such a fashion that the set, the reception time, and the generation flag are associated (S13). Thereafter, the process returns to step S11.

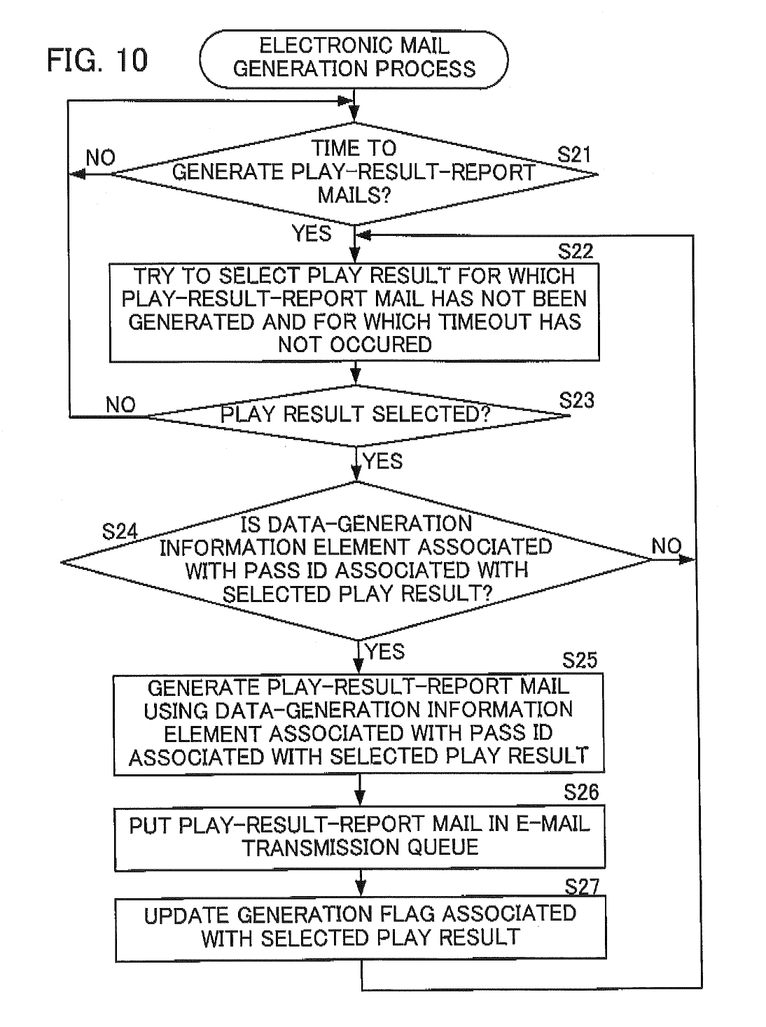

FIG. 10 is a flowchart showing the flow of the electronic mail generation process. As shown in FIG. 10, in the electronic mail generation process, the processor 44 first determines whether or not it is the time to generate play-result-report mails (S21). If the determination is “No”, the process returns to step S21. That is, the processor 44 waits until the time to generate play-result-report mails. In this embodiment, the processing program 435 is designed so that play-result-report mails should be generated periodically. Thus, the determination at step S21 becomes “Yes” periodically.

If the determination at step S21 is “Yes”, the processor 44 tries to select play results for which play-result-report mail has not been generated and for which a certain time has not been passed since the reception time (timeout has not occurred) (S22). More specifically, the processor 44 tries to select, from among the play result management table 431, a play result to which a generation flag indicating that an electronic mail containing the play result has not been generated is associated and to which a reception time within a certain period (for example, 24 hours) before the current time point is associated.

Next, the processor 44 determines at step S23 whether or not a play result was selected at step S22. If the determination is “Yes”, the processor 44 determines whether or not a data-generation information element is associated with the pass ID associated with the selected play result (S24). This determination is accomplished by referring to the first association table 432, seeking the player ID associated with the pass ID associated with the selected play result, referring to the second association table 433, and seeking the data-generation information element associated with the sought player ID in the second association table 433.

If the determination at step S24 is “No”, the process returns to step S22. The play result for which the determination at step S24 was “No” should not be selected at step S22 until the next time to generate play-result-report mails. The scheme for this purpose is optional, but, for example, another flag may be associated with each play result in the play result management table 431 shown in FIG. 6, the flag may be reset at each time to generate play-result-report mails and may be set when the determination at step S24 is “No”. At the selection of step S22, if the flag is set, the corresponding play result is excluded from the subject of selection.

If the determination at step S24 is “Yes”, the processor 44 produces or generates a play-result-report mail using the data-generation information element (electronic mail address) associated with the pass ID associated with the selected play result (S25). That is, the processor 44 serves as a generator for using the data-generation information element associated with the player ID associated with each pass ID contained in the above-mentioned set received at the receiver to generate a play-result-report mail of which the body contains the play result contained in the set.

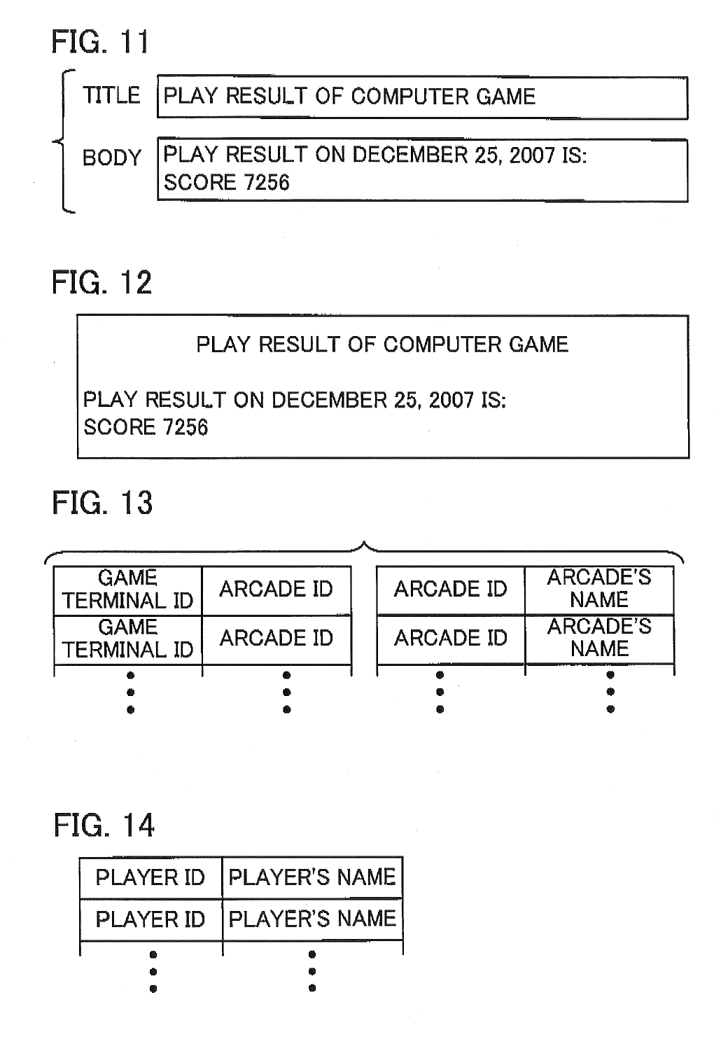

For example, the processor 44 produces an electronic mail, as shown in FIG. 11, of which the title is “PLAY RESULT OF COMPUTER GAME”, of which the first line of the body is “PLAY RESULT ON DECEMBER 25, 2007, IS:”, of which the second line of the body is “SCORE 7256”, and of which the source mail address is the data-generation information element associated with the pass ID associated with the selected play result. In FIG. 11, “December 25, 2007” is a character string indicating the date in the reception time associated with the selected play result, and “7256” is a character string indicating the selected play result (score).

The processor 44 puts the generated play-result-report mail in the e-mail transmission queue 434 (S26), and updates the generation flag associated with the selected play result so as to indicate that an e-mail containing the play result has been generated (S27). Thereafter, the process returns to step S22. Thus, steps S22 through S27 are repeated until there is no play result for which a play-result-report mail has not been generated and for which timeout has not occurred. If the processor cannot select a play result for which a play-result-report mail has not been generated and for which timeout has not occurred, so that the determination at step S23 is “No”, the process returns to step S21.

In the above-described electronic mail generation process, multiple play-result-report mails are sequentially put in the e-mail transmission queue 434. These play-result-report mails are sequentially transmitted to the webpage production system 5. Upon receiving a play-result-report mail, the webpage production system 5 determines whether or not the source mail address of the play-result-report mail is one of electronic mail addresses registered with the webpage production system 5 in advance. If so, the webpage production system 5 generates or produces a webpage describing the title and the body of the play-result-report mail, and adds the webpage to the website for the user corresponding to the source mail address.

FIG. 12 is a view showing an image of a webpage produced by the webpage production system 5 and corresponding to FIG. 11. As will be clear from FIGS. 11 and 12, the title of the play-result-report mail is converted to the title of the webpage, whereas the body of the play-result-report mail is converted into the matter of the webpage.

As has been described above, the communication system 1 includes the play result processing system 4 for transmitting a message to the existent webpage production system 5 that receives an electronic mail of which the source mail address is the electronic mail address that is unique to the user, generates a webpage describing the title and the body of the electronic mail using the electronic mail, and adds the generated webpage to a website for the user. The play result processing system 4 includes a first association table 432 for storing player IDs each of which is unique to a player of a computer game and for storing pass IDs each of which is unique to an ID pass 2 used for playing the computer game, each one of the player IDs being associated with at least one of the pass IDs in the first association table 432; a second association table 433 for storing the player IDs and electronic mail addresses (data-generation information elements), each of the electronic mail addresses being unique to the player, the player ID for each single player being associated with the electronic mail address for the player in the second association table 433; a receiver for receiving data indicating a set including a play result which is a result of play of the computer game and a pass ID for an ID pass 2 used for the play; a generator for generating an electronic mail of which the source mail address is the electronic mail address associated, in the first association table 432 and the second association table 433, with the pass ID contained in the set indicated by the data received at the receiver and of which the mail body contains the play result contained in the set; and a transmitter for transmitting the generated electronic mail to the webpage production system 5. Thus, the embodiment can automatically produce a webpage describing the result of a play by a player and can add the webpage to an individual website for the player even though the system is of a simple structure.

In the communication system 1, the message sent from the play result processing system 4 to the webpage production system 5 is an electronic mail. The communication protocol for electronic mails is widely popular, and therefore this embodiment can reduce the effort for constructing the play result processing system 4 and can use many types of webpage production systems, in comparison with another aspect in which a message is sent in accordance with a communication protocol that is not popular.

In the communication system 1, if a single player possesses multiple ID passes (information storage mediums) 2, multiple pass IDs (medium identifiers) are associated with a single player ID (player identifier) as shown in FIG. 7. In addition, each data-generation information element is associated with a player ID, rather than a pass ID. Accordingly, by virtue of the communication system 1, even though a single player uses multiple ID passes 2, it is possible to prevent webpages each produced automatically for the result of a play by the single player from being distributed to multiple websites.

### Modifications

In a modification of the above-described embodiment, the embodiment may be applied to computer games other than the above-described computer game. For example, the embodiment may be applied to a computer game in which multiple players can participate. In this case, multiple sets each including a play result a pass ID per play will be stored in the play result processing system 4. A play ID unique to each play may be associated with those sets, and the play ID may be contained in the title or the body of the play-result-report mail, and the resultant multiple webpages may be mutually linked by tags or hyperlinks.

In a modification of the above-described embodiment, the embodiment may be applied to different computer games. In this case, a player possessing only one ID pass (information storage medium) 2 will use the sole ID pass for multiple computer games, whereas another player possessing multiple ID passes (information storage media) 2 may use these ID passes for different computer games, respectively, or may use only one of these ID passes for different computer games. In either case, since a single player ID (player identifier) is associated with multiple pass IDs (medium identifiers), and the data-generation information element is associated with the player ID, the webpage describing the play result is added to the one individual website for the corresponding player irrespective of the type of computer game.

In a modification of the above-described embodiment, the play result described in the webpage may be a parameter other than the score, for example, victory or defeat, or ranking, or it may include multiple parameters. For example, if a play is constituted of multiple stages, the play result may include a score at each stage and serial numbers of the stages. If points or evaluations other than score are given in a play, the play result may include the points or the evaluations.

In a modification of the above-described embodiment, the play result processing system 4 may transmit play-result-report mails of which titles are blank or may transmit play-result-report mails that do not indicate the reception time. Alternatively, the play result processing system 4 may transmit play-result-report mails, in each of which the title indicates the play result and in each of which the body is blank, or may transmit play-result-report mails, in each of which the title indicates an element of the play result and in each of which the body indicates another element of the play result.

In a modification of the above-described embodiment, each play-result-report mail may contain information other than the play result and the reception time in the title or the body thereof. Such information may be, for example, the hyperlink of a video file corresponding to the music composition used in the play, the arcade's name, and the player's name. Hereinafter, with reference to FIGS. 13 and 14, modifications related to arcade names and player names are described.

An alternative play result processing system that transmits play-result-report mails each having the title or the body indicating the arcade's name may store a data table shown in FIG. 13. The alternative play result processing system is based on each game terminal 3 transmitting a set including a game terminal ID unique to the game terminal 3, the pass ID, and the game result. The play result processing system generates or produces a play-result-report mail having the title or the body indicating the arcade name (for example, “Akasaka Branch, Minato Ward, Tokyo, Japan”) associated with the arcade ID associated with the game terminal ID indicated by the received set, in addition to the play result indicated by the received set.

An alternative play result processing system that transmits play-result-report mails each having the title or the body indicating the player's name may store a data table shown in FIG. 14. The alternative play result processing system generates or produces a play-result-report mail having the title or the body indicating the player's name (for example, “Ichiro Suzuki”) associated with the player ID associated with the pass ID indicated by the received set, in addition to the play result indicated by the received set.

In a modification of the above-described embodiment, the play result processing system 4 may transmit to a webpage production system messages of which the type is different from that of electronic mails. Even in this modification, the message sent from the play result processing system 4 to the webpage production system should be a message indicating information in a manner that is unique to a user corresponding to the information (for example, a message to which information for identifying the user is attached, or a message in which the information arrangement or the style is unique to the user), and the data-generation information element associated with the player ID in the second association table should be information necessary for generating a message that indicates information in a manner that is unique to the player identified by the player ID, i.e., information that can identify the user.

In a modification of the above-described embodiment, each game terminal 3 may prompt the player to input an instruction instructing whether or not the webpage describing the play result should be generated in advance of transmission of the set of the pass ID and the play result, and may transmit the instruction together with the set to the play result processing system 4. The play result processing system 4 may exclude, from the subject of selection at step S22 shown in FIG. 10, the play result sent together with the instruction instructing not to generate the web page.

In a modification of the above-described embodiment, each game terminal 3 may transmit separately pass ID and the play result to the play result processing system 4. For example, the pass ID may be sent prior to the start of a play, whereas the play result may be sent after the end of a play.

In a modification of the above-described embodiment, the game terminal 3 may be a home-use game console.

The play result processing system 4 may be composed of multiple computers, but in this case, the communication path connecting the multiple computers is not an element of the play result processing system 4.

1. A play result processing system for transmitting a message to a webpage production system that receives a message indicating information in a manner that is unique to a user corresponding to the information, generates a webpage describing the information using the message, and adds the generated webpage to a website for the user, the play result processing system comprising:
a first storage part for storing player identifiers each of which is unique to a player of a computer game and for storing medium identifiers each of which is unique to an information storage medium used for playing the computer game, each one of the player identifiers being associated with at least one of the medium identifiers in the first storage part;
a second storage part for storing the player identifiers and data-generation information elements, each of the data-generation information elements being necessary for generating a data element that indicates a message in a manner that is unique to the player corresponding to the message, the player identifier for each single player being associated with the data-generation information element for the player in the second storage part;
a receiver for receiving data indicating a set comprising a play result which is a result of play of the computer game and a medium identifier for an information storage medium used for the play;
a generator for generating a message that indicates the play result contained in the set indicated by the data received at the receiver in a manner that is unique to a player, the manner depending on the data-generation information element associated in the second storage part with the player identifier that is associated in the first storage part with the medium identifier contained in the set indicated by the data received at the receiver; and
a transmitter for transmitting the message generated at the generator to the webpage production system.

2. The play result processing system according to claim 1, wherein the data-generation information element is an electronic mail address for the player,
wherein the generator generates an electronic mail, as the message, comprising a source mail address, a body, and a title, the source mail address being the data-generation information element associated in the second storage part with the player identifier which is associated in the first storage part with the medium identifier contained in the set indicated by the data received at the receiver, the body or the title comprising the play result contained in the set, and
wherein the transmitter transmits the electronic mail to the webpage production system.
